(19) United States
(12) Patent Application Publication
(10) Pub. No.: US 2008/0108301 A1
(43) Pub. Date: May 8, 2008

(54) Method and Apparatus for Synchronizing Programming Content Between a Vehicle and a Residential Network

(75) Inventor: Jheroen P. Dorenbosch, Paradise, TX (US)

Correspondence Address: Motorola, Inc.;Law Department, 1303 East Algonquin Road, 3rd Floor, Schaumburg, IL, 60196, US

(73) Assignee: GENERAL INSTRUMENT CORPORATION, Horsham, PA (US)

(21) Appl. No.: 11/557,166

(22) Filed: Nov. 7, 2006

(51) Int. Cl. H04H 60/09

(52) U.S. Cl. 455/3.06

(57) ABSTRACT

A method and apparatus is provided for synchronizing programming content between a mobile apparatus (e.g., a vehicle) and a residential network. The method begins by receiving a wireless content-identifying signal from a mobile apparatus through an access device located on a premises. The wireless content-identifying signal identifies a first source of programming content that is available to a first rendering device associated with the mobile apparatus. Based on the wireless content-identifying signal, a second source of the programming content is identified which is available to a second rendering device located on the premises. A control signal is transmitted to the second rendering device directing the second rendering device to access and render the programming content.

### FIELD OF THE INVENTION

The present invention relates generally to a method and apparatus for synchronizing programming content between a vehicle and residential network.

### BACKGROUND OF THE INVENTION

Electronic devices such as televisions, radios, and computers are becoming increasingly popular for use in automobiles, trucks, vans, and recreational vehicles such as campers and boats. Such in-vehicle devices, including Internet-enabled personal digital assistants (PDAs) and wireless cellular telephones, are also becoming more and more integrated with the vehicles. Consequently, car, truck, van, and motor home manufacturers and suppliers have become increasingly aware of the need to provide for the installation or accommodation of various electronic devices such as video screens in their automobiles. Thus, attempts are currently being made to equip vehicles with high-technology communication systems, which can permit mobile users to convert previously wasted commuting time into productive work or entertainment hours. It is anticipated that multimedia technologies will advance tremendously in the coming years, and that so-called “telematics” (i.e., in-vehicle multi-media and telecommunications systems) will increasingly become a part of everyday vehicle usage. As mobile users become more and more accustomed to the enjoyment of multimedia technologies in their vehicles that in quality and variety begin to rival what they have available in their homes, their expectations for a seamless integration of their mobile and home entertainment systems is likely to increase.

One of the problems or frustrations that a mobile user faces when using an in-vehicle device such as a television, radio, CD player or the like occurs when the user needs to interrupt a program or song upon completion of his or her trip so that the user can depart from the vehicle. The mobile user will sometimes remain in the vehicle until the program or song is completed, despite having arrived at his or her destination. Alternatively, the mobile user leaves the vehicle thereby missing the remainder of the program or song, or at least a portion of the program or song if the user is able to enter the premises (e.g., home, office and the like) and continue viewing and/or listening to the programming from another independent source. Similarly, an individual listening or watching a program or song in his or her home, office or other premises often needs to interrupt the program or song when leaving the premises and entering the vehicle.

Another common frustration mobile users sometimes face involves a child who is present in the vehicle and watching a DVD. In some cases the child will be reluctant to leave the vehicle when arriving at home because he or she has not completed viewing the DVD.

Accordingly, it would be desirable to provide a more seamless transition so that users can continue accessing the program, song or the like as they move between the premises and the mobile vehicle.

### BRIEF DESCRIPTION OF THE DRAWINGS

FIG. 1 is a block diagram illustrating an example of an operating environment in which a home network communicates with a vehicle communication platform (e.g., a telematics unit) of a vehicle.

FIG. 2 shows an example of wireless access point that may be employed in the home network depicted in FIG. 1.

FIG. 3 shows a functional block diagram of one example of the vehicle communication platform located in vehicle depicted in FIG. 1.

FIG. 4 illustrates one example of the logical composition of a single message of the content-identifying signal.

FIG. 5 is a flowchart showing one example of a process for synchronizing programming content between the vehicle and the home network.

FIG. 6 shows one example of a hardware platform that may be used in either the vehicle or the home to implement the methods described herein.

FIG. 7 is a flowchart that shows one example of a process performed by the hardware platform depicted in FIG. 6 and the systems located in the vehicle or home that renders synchronized content in response to receipt of a content-identifying signal from the hardware platform.

### DETAILED DESCRIPTION

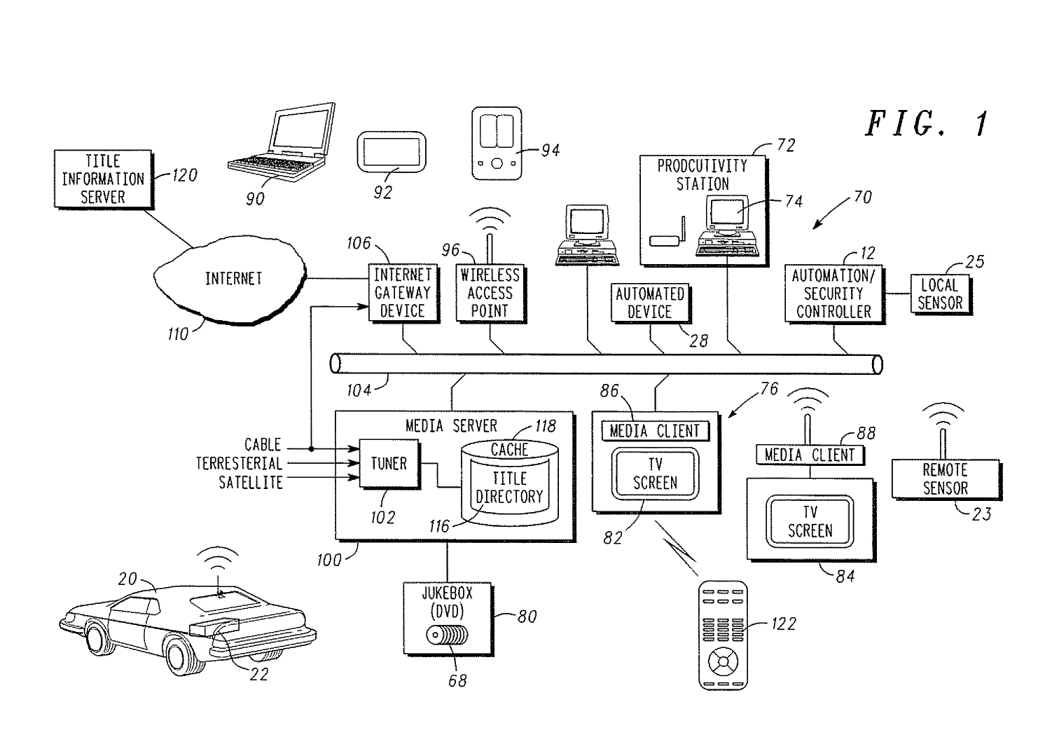

FIG. 1 is a block diagram illustrating an example of an operating environment in which a home network 70 communicates with a vehicle communication platform 22 (e.g., a telematics unit) of a vehicle 20. While for convenience network 70 is referred to as a home network, network 70 more generally may be situated on any premises such as an office, a building, an outdoor venue and the like. The home network 70 may be built on a communications infrastructure 104 (e.g., a LAN) that may employ any suitable suite of communication protocols (e.g. IP-based Ethernet, MOCA, powerline based systems). In the example illustrated in FIG. 1, the home network 70 connects devices for work, entertainment, security and automation functions. For instance, a productivity station 72, which may be located in the study room of the house, includes a desktop personal computer 74 that may be connected to the home network via wired or wireless connections. An entertainment center 76, which may be located in the family room, contains video/audio equipment including a display device (e.g., television) 82. The display device 82 has a media client 86 (e.g., a set top box) that provides connectivity to the home network 70. Another display device 84, which may be located in the bedroom, is also connected to the home network 70 by media client 88. In some examples the home network 70 is a wired network, a wireless network or part wireless and part wireless network. To that end, the home network 70 includes one (or more) wireless access points (WAP) 96 that functions as the base station for a wireless local area network (LAN) and is typically plugged into an Ethernet hub or server. In addition to providing connectivity to the aforementioned devices, a wireless LAN may be especially suitable for portable devices such as notebook a computer 90, a tablet PC 92, and a PDA 94, for example.

It should be noted that home network 70 need not include all of the various components and functionality discussed above, which are presented for purposes of generality. That is, the home network need not include all the various home entertainment, security and automation functions described herein.

The home network 70 includes a media center or server 100. The media server may be located, for instance, in an equipment room. The media server 100 may be implemented as a general-purpose computer. Alternatively, the media server 100 may be a dedicated microprocessor-based device, similar to a set-top box, with adequate hardware and software implementing media service related functions. The media server 100 includes a tuner 102 to connect it to various remote media sources. The tuner 102 may receive signals from different carriers such as satellite, terrestrial, or cable (broadband) connections or directly from RF broadcasts transmitted over the airways. The media server 100 may be provided with capabilities to access the Internet 110. In the illustrated example, the media server 100 is connected to an Internet gateway device (IGD) 106, which may be connected to the Internet via a cable or phone line (i.e., publicly switched telephone network (PSTN)). In the illustrated example, the Internet gateway device 106 is also used by the personal computer 74 in the productivity station 72 to access the Internet 110.

The media server 100 can access one or more local media sources 68 (e.g., electronic storage media such CDs, DVDs and magnetic storage media such as a hard disk) using a rendering device 80 (e.g. video/audio playback devices such as CD and DVD players, DVRs). In the example shown in FIG. 1 rendering device 80 is depicted as a jukebox that enables a user to select content stored on CDs or DVDs 68. As used herein, the term “jukebox” means a video/audio playback device that provides physical storage space for multiple media sources (CDs or DVDs 68) and has a mechanism for picking out each storage medium source and retrieving the content on that medium source. For purposes of illustration, the jukebox will be described as a CD jukebox 80 that has a plurality of CDs 68 stored therein. It will be appreciated, however, that a CD jukebox is only one example, and jukeboxes for other types of media sources for video/audio signals may also be used in the home entertainment system. The media server 100 may also access other local media sources such as a hard disk 118 or other mass storage medium.

It should be emphasized that media server 100 shown in FIG. 1 is only one example of a media server and is presented by way of illustration only. Those skilled in the art will appreciate that the media server can be structured differently from that illustrated, and can include additional or less functionality than described above. The media server 100 may offer, for instance, digital video, audio, and high speed-data services along with streaming media, PPV, Internet services, video-on-demand, HDTV, and personal video recorder (PVR) capabilities. Moreover, the media server may be associated with, or provide the functionality of, any one or more of the following: a television, a tuner, a receiver, a set-top box, and/or a Digital Video Recorder (DVR). The media server may comprise one or many devices, each of which may have fewer or more components than described herein. Similarly, the media server may be a component or attachment of another device having functionality that may differ from that provided by the media server. For instance, the functionality of the media server may be combined with the functionality of the automation/security controller, discussed below, to form a centralized command center for the home network 70.

In any case, regardless of the various features and functionality that it offers, an important aspect of the media server is that it is a centrally located means for storing programs that are readily and contemporaneously accessible by, and readily and contemporaneously controllable by, multiple local client devices via the home network. It should be emphasized however, that the techniques and arrangements described herein do not require a media server. For instance, the techniques and arrangements described herein are also applicable to a home network that includes only a single rendering device that communicates rendered programming content (e.g., video and/or audio) to a single display, speaker or the like. That is, by way of example, the home network may only include a single entertainment center that simply comprises a stereo system and an interface to communicate with the vehicle.

As previously noted, the home network 70 in FIG. 1 also includes a control unit 12 for controlling security and automation components such as one or more remote sensors 23, local sensors 25, and/or automated devices 28. The remote sensors 23 may be hard-wired to the communication infrastructure 104 or connected wirelessly via WAP 96. The central control unit 12 optionally may also be hardwired to one or more local sensors 25 separately and independent from communications infrastructure 104. Sensors 23 and 25 may be any appropriate device that can monitor and detect a defined condition and, in response to a detected condition, generate a warning. These conditions include, for example, entrance to and departure from the premises, security breaches, fire hazards, carbon monoxide and power failure and electrical power outages. Automated devices 28 may include networked appliances (e.g., motion sensors, cameras, refrigerators, ovens, lights, television and stereo units, and media centers) and other automation and control devices and systems such as lighting, heating and air conditioning, garage door openers, window shades or curtains, pool heaters and filtration systems, lawn sprinklers, and ornamental fountains, which provide both monitoring and control capabilities.

WAP 96 may be implemented as a base station, router, switch, access point, or similar device that can communicate over a wireless LAN with external devices. WAP 96 may be an independent unit or it may incorporated with other components such as the Internet Gateway Device 106 or the security control unit 12. The wireless LAN may use any of a variety of different physical and data link communication standards. For example, such systems may use, without limitation, IEEE 802.11 (e.g., 802.11a; 802.11b; 802.11g), IEEE 802.15 (e.g., 802.15.1; 802.15.3, 802.15.4), DECT, PWT, pager, PCS, WiFi, Bluetooth™, cellular, UMTS, EV-DO and the like. Various network level protocols may be used over any of the aforementioned physical and data link standards to provide communication among the various components of the wireless LAN. While the IP protocol suite is used in the particular implementations described herein, other standard and/or communication protocols are suitable substitutes. For example, X.25, ARP, RIP, UPnP or other protocols may be appropriate in particular installations. It should be noted that the protocols and standards used to establish communication among the components within the communications infrastructure 104 may be but are not necessarily the same as the protocols and standards used to establish communication over the wireless LAN between the WAP 96 and external access devices.

As shown in more detail in FIG. 2, the WAP 96 includes a bus interface 242, processor 286 having ROM 288 and RAM 290, and programming port 292, front-end transceiver 246, network interface controller 270 and antenna port 282. The bus interface 242 is provided to communicate with the network infrastructure 104. The bus interface 242 forwards the signals received over the network infrastructure 104 to the processor 286. The configuration of front-end transceiver 246 will depend on the particular physical and data link communication standards noted above that the external access device uses to communicate with the WAP 96. Network interface controller 270 may include the functionality of a switch or router and also serves as an interface that supports the various communication protocols, e.g., IP, that are used to transmit the data over the wireless network. The WAP 96 may also include RAM port 298 and ROM port 200 for, among other things, downloading various network configuration parameters, and upgrading software residing in the processor 286. User interface 295 (e.g., a keypad/display unit) allows control of the various user-adjustable parameters of the WAP 96.

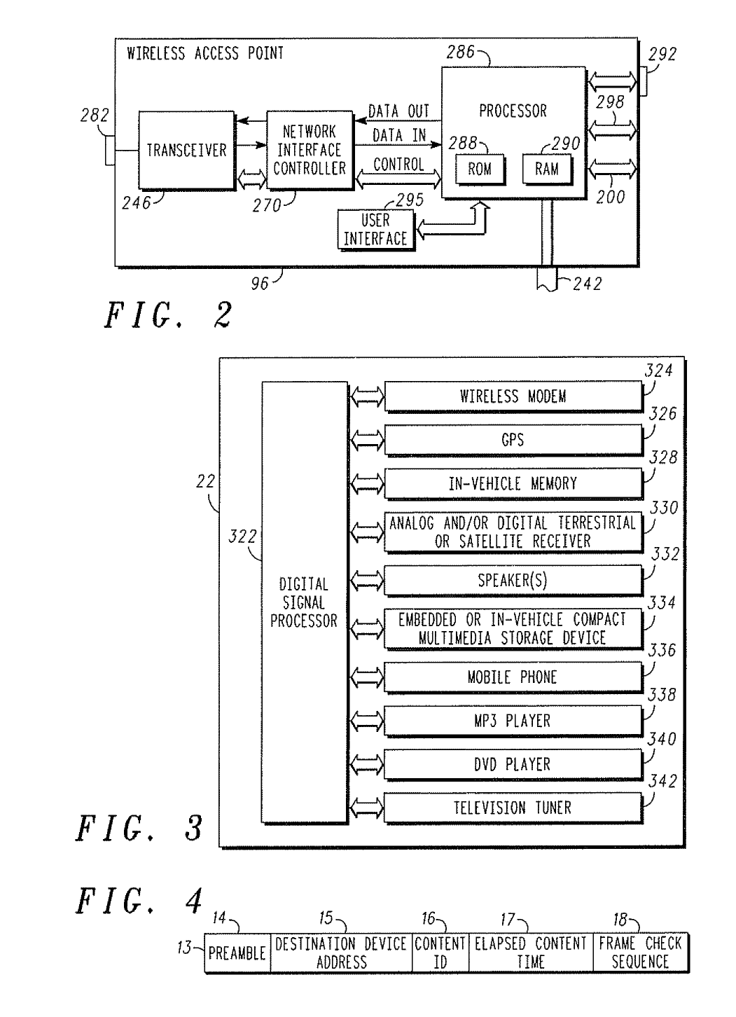

FIG. 3 shows a functional block diagram of one example of the vehicle communication platform 22 located in vehicle 20 of FIG. 1. For purposes of illustration only the vehicle communication platform 22 is depicted as a telematics unit, which are increasingly being deployed in vehicles. The systems and methods described herein may be incorporated with such a telematics unit to achieve the benefits described herein.

Vehicle communications platform 22 includes a processor 322, which may be a digital signal processor (DSP), connected to a wireless modem 324, a global positioning system (GPS) unit 326, an in-vehicle memory 328, an analog and/or digital terrestrial or satellite receiver 330, one or more speakers 332, an embedded or in-vehicle compact multimedia storage device 334, such as a disc (CD) player, an embedded or in-vehicle mobile phone 336, an MP3 player 338, a DVD player 340 and a television tuner 342. Wireless modem 324 is generally implemented as any suitable system for communicating over a wireless network. However, for the purposes described herein, wireless modem 324 need only be implemented as any suitable system for transmitting to and receiving a signal from the home network 70, for example via the WAP 96 shown in FIG. 1 over a wireless link. GPS unit 326 provides longitude and latitude coordinates of the vehicle 20. In one implementation the in-vehicle memory 328 may contain the longitude and latitude coordinates of the premises and the processor 322 can determine the distance between the vehicle and the premises. The in-vehicle memory 328 may also contain a predetermined distance threshold so that the processor 322 can determine whether the vehicle and the premises are within or at a predefined proximity of one another. In-vehicle mobile phone 334 is a cellular-type phone, such as, for example an analog, digital, dual-mode, dual-band, multi-mode or multi-band cellular phone. Receiver 330 receives analog and/or digital RF broadcast signals to be rendered on a rendering device such as the speakers 332 or a video display (not shown). In-vehicle multimedia storage device 334 may be implemented, for example, as a conventional in-vehicle CD player or portable CD player interfaced with the processor 322 or a multimedia database on a hard disk or memory stick. In some cases in-vehicle CD player 334 is implemented as an integrated entertainment component, such as, for example an embedded CD player that is integrated with the receiver 330.

As previously mentioned, one of the problems or frustrations that a mobile user faces when using an in-vehicle rendering device such as a radio, CD player or the like occurs when the user needs to interrupt a program or song upon completion of his or her trip so that the user can depart from the vehicle. The mobile user will sometimes remain in the vehicle until the program or song is completed, despite having arrived at their destination. Similarly, an individual listening or watching a program or song in his or her home, office or other locations often needs to interrupt the program or song when leaving the premises and entering the vehicle.

To overcome this problem, communication is established between the home and the vehicle to coordinate their respective media sources so that the same programming content is being rendered in both environments. For example, if the mobile user in the vehicle is listening to a radio station when arriving at home, the vehicle notifies the media server 100 (via WAP 96) that it needs to synchronize its tuner with the vehicle's radio by tuning to the station currently being received by the radio. The media server 100 then transmits that station's broadcast signal over the communications infrastructure 104 to one or more selected speakers in the home. In this way when the user exits the vehicle and enters the home he or she will be able to continue listening to the broadcast with minimal interruption. Likewise, if a user is listening to a radio station at home when he or she needs to depart in the vehicle, the home network notifies the receiver in the vehicle (via wireless modem 324) that the receiver needs to synchronize its tuner with the home radio by tuning to the station currently being received by the home radio. The home network may also provide other information to the vehicle such as volume settings, tone settings, and the like. In this way when the user exits the home and enters the vehicle he or she will be able to continue listening to the broadcast with minimal interruption.

The following illustrative scenario assumes that the mobile user is listening to programming content from the receiver 330 (or other programming content stored on any of various media sources or broadcast to other rendering devices in the vehicle) in the vehicle when returning home. The reverse process, which is performed in an analogous manner when the user leaves the home and enters the vehicle, will be discussed thereafter.

To coordinate the media sources in the vehicle with those in the home so that the same programming content is being rendered in both environments the vehicle needs to send a content- or program-identifying signal that includes information identifying the station currently being played on the vehicle's receiver 330. This signal should be transmitted when the vehicle approaches the vicinity of the home (e.g., when the vehicle enters the driveway of the home). This authorization process and the attendant handshaking (i.e., the sequence of events governed by hardware and/or software, requiring mutual agreement of the state of the operational modes prior to information exchange.) that is used for implementing the synchronization process between the vehicle and the home may be achieved in any manner known to those of ordinary skill in the art.

FIG. 4 illustrates one example of the logical composition of a single message 13 (e.g., one or more packets) of the content-identifying signal. The message itself consists of a variable number of octets, or 8 bit data units, and is divided into fields of an integral number of octets as shown. The nomenclature and purpose of the fields is as follows. The preamble 14 is a unique set of bits used to synchronize the reception of messages. The destination device address 15 is a pattern that specifies the address of the device or devices (e.g., media server 11) that are to receive the message. The content ID 16 specifies the content or program that is currently being rendered. For example, depending on the particular content that is being rendered, the content ID 16 may include such information as the radio station currently being played, the name or other identifier of a CD or DVD being played, and the like. The elapsed time field 17 refers to the point in programming that is currently being rendered at the time the content-identifying signal is transmitted. This field will generally be applicable to content available from a CD or DVD rather than from a broadcast source. For instance, the elapses time field 17 may indicate how many minutes and seconds of a selection (e.g., song) have already been rendered. The FCS 18 is check sequence that is used by the destination stations to assess the validity of the received message. It should be noted that the composition of the message depicted in FIG. 4 is presented for illustrative purposes only. That is, the messages making up the content-identifying signal may have additional, fewer, and/or different fields from those described herein.

The information in the content-identifying signal that identifies the station currently being played in the vehicle may be obtained in any appropriate manner. For instance, the DPS 322 can determine the station to which receiver 330 is tuned and then incorporate this information in the synchronizing request. Alternatively, if available, RDS (Radio Data System) information embedded in the RF broadcast signal may be forwarded by the wireless modem 324 to the media server 100.

More generally, the information in the content-identifying signal can be obtained either from an examination of the rendering device or an examination of the content itself. If the rendering device is to be examined, its status can be determined by the DPS 322. For example, the DPS 322 can determine that the CD player, for instance, has been activated. Alternatively, if the content is being examined, various identifying information that is embedded with the content may be used. For instance, if a CD is being rendered, the CD will often include a table of contents (as CD-TEXT information, for example) from which the identifying information can be obtained.

Any of a wide variety of triggering events may be employed to initiate transmission of the content-identifying signal when in the vicinity of the home. In general, either a push or pull model may be employed. In a typical client/server environment involving a push interaction, the server transmits information to the client without explicit instruction from the client to do so. This interaction is referred to as a push, since the server is effectively pushing information to the client. In the present case, for example, the vehicle may push the content-identifying signal to the home. The signal may be pushed to the home for any of a number of different triggering events. In as simple case, for instance, the signal may be pushed when the user manually activates the system to transmit the content-identifying signal using, for example, a button that is dedicated for this purpose. Alternatively, the signal may be automatically sent or pushed when one of the vehicle's doors is opened, when the user activates a garage door opener, when the vehicle's GPS system determines that the vehicle has arrived at the home, or upon occurrence of some other triggering event.

In a typical client/server environment involving a pull, the client engages a server with a request for service or information. The server responds to the request and returns information to the client. This interaction is referred to as a pull, since the client is effectively pulling information from the server. For example, the media server 100 may pull the content-identifying signal by sending a request to the vehicle upon occurrence of a triggering event or at regular intervals.

The foregoing triggering events will generally use the vehicle's internal communication systems to forward a signal from the appropriate device or sensor (e.g., the vehicle door, the garage door opener embedded in the vehicle, the GPS system) to the DSP 322 in the vehicle communications platform 22, which in turn will direct the wireless modem 324 to transmit the content-identifying signal to the media server 100. In the case of such triggering events initiated from the vehicle, the content-identifying signal should include a request that the media server 100 synchronize its media source to the station identified in the content-identifying signal. That is, the triggering signal the triggering signal and the content identifying signal may be incorporated in a common wireless signal. Alternatively, as part of the handshaking process a separate synchronization request signal may be sent in a different transmission signal from the vehicle 20 to the media server.

In addition to the aforementioned internal triggering events originating from the vehicle 20, a variety of external triggering events may be used to notify the media server 100 that the vehicle 20 has arrived at the home. For example, a sensor (e.g., sensor 23 in FIG. 1) in the driveway, garage or other location may detect the presence of the vehicle 20. The sensor, which may be incorporated in the home network 70, may forward the signal to the media server 100, either through the communications infrastructure 104 or wirelessly through the WAP 96. The sensor, the communications infrastructure or the media server 100 may be programmed with information that allows the recognition of one or more predetermined vehicles, so that the external triggering events may selectively be used to notify the media server 100 that a specific vehicle 20 has arrived at the home. When an external triggering event of this type is employed, the media server 100, in a pull mode of operation, sends a synchronization request signal to the vehicle 20 requesting receipt of the current state of the content being rendered (e.g., the current radio station being played). In response, the vehicle 20 transmits the content-identifying signal via wireless modem 324. In yet another alternative, the user may be carrying an RF tag on his person (e.g., on a keychain or incorporated in a security key card) that allows the vehicle and the home network to determine when the user is in either location.

Synchronization between the programming content being rendered in the vehicle 20 and the home network can also be achieved in a variety of other ways that do not employ a triggering event. For example, the WAP 96 could transmit periodic queries to determine if the vehicle 20 is in the vicinity of the home. Upon receipt of the query from the home, the vehicle 20 sends the content-identifying signal to the home. This approach may be particularly appropriate when the vehicle 20 and home network are in communication using a relatively short range communication standard such as Blue-tooth or WiFi, for instance, in which case queries will only be recognized when the vehicle 20 is in the immediate vicinity of the home network. In another arrangement that avoids the need for a triggering event, the vehicle may scan for the WAP 96 and initiate communication with it once found.

The aforementioned illustrative scenario assumed that the mobile user was listening to programming content from the receiver 330 (or programming content from other rendering devices in the vehicle 20) in the vehicle 20 when returning home. In addition, the arrangement described herein can also be used to synchronize programming content when the user is listening to the radio in the home and then departs to begin a trip in the vehicle 20. In this case a triggering event may be used to request the receiver 330 (or other media source) in the vehicle 20 to begin rendering the same programming content that was being played in the home. Once again, any of a wide variety of triggering events may be employed to initiate transmission of a content-identifying signal from the home (via the WAP 96) to the wireless modem 324 in the vehicle 20. For example, the content-identifying signal may be transmitted when the user presses a dedicated button located in the home or when the user opens a door to gain access to the vehicle 20 or to the garage or when the user is using a button or other actuator located in or near the garage, thereby detecting that the user may want to enter the vehicle to leave the premises. Alternatively the actuator opening the garage door may be connected to the communications infrastructure 104 so that it can instruct the WAP 96 to transmit the content-identifying signal at the appropriate time. Alternatively, the content-identifying signal may be transmitted when the user enters the vehicle 20 by opening the vehicle door using a remote control unit such as those typically provided as a part of the keychain to which the vehicle's keys are affixed. In this case the remote control unit sends a signal (the same or a different signal from that used to open the vehicle door) to the WAP 96, which in turn transmits the content-identifying signal to the wireless modem 324 in the vehicle 20. The content-identifying signal is then forwarded by the wireless modem 324 to the DSP 322 in the vehicle communication platform 22, which in turn activates the receiver 330 and directs it to tune to the same station that was being played in the home.

The previously discussed examples all assumed that the user is listening to or watching a broadcast provided by a radio or television station or the like. In other cases, however, the user may be listening to or watching a program that is being rendered from a local media source such as a CD, a DVD, or a hard drive storing MP3 or other multimedia files. If this is the case, synchronization will only occur if both the vehicle 20 and the media server 100 have access to the same program or file. For purposes of illustration an example will be presented in which a mobile user in the vehicle 20 is listening to a particular track of a CD at the time he or she arrives at home.

Similar to the situation arising when the user is listening to or watching a broadcast, upon occurrence of a triggering event such as any of those described above, the vehicle 20 transmits to the media server 100 a content-identifying signal that identifies the selection currently being rendered by the CD player 334.The identification of the selection may be located in the content ID field 16 of the packet shown in FIG. 4 or in some other field. For example, the identifying information may include the CD title and the currently playing track number or other identifier such as the song title. Such identifying information can be obtained in a number of ways. For instance, if available, the information can be obtained directly from the CD-TEXT information available in the TOC (Table of contents) of the CD, which is generally stored on the lead-in portion of the CD. The CD-TEXT information may also be available in the program area of the CD in a format that follows the Interactive Text Transmission System (ITTS).

Upon receipt of the content-identifying signal that identifies the song or other programming currently being played, the media server 100 searches its local media source or sources to determine if it has the same programming content available. In the example shown in FIG. 1, for instance, the media server 100 searches the plurality of CDs 68 located in the jukebox 80 to determine if the CD playing in the vehicle 20 is available. If so, the media server 100 instructs the jukebox to retrieve and play the CD so that it may be distributed over the communications infrastructure 104 for rendering by selected speakers throughout the home. These instructions from the media server 100 may be sent in a control signal that is distinct from the content-identifying signal shown in FIG. 4. A separate control signal will typically be needed since the content-identifying signal will generally not dictate where in the home the content is to be rendered. Optionally, if the particular CD is unavailable, the media server 100 may also search other local media sources such as a hard drive or the like to determine if the same content is available in a different format. If this option is unavailable, another option may be to download or stream the content from the vehicle to the home network (or visa versa for the implementation where the user is departing from the premises).

To locate a particular item on a CD or DVD stored in jukebox 80 or on a hard drive or other local or networked storage medium, media server 100 maintains one or more databases. For instance, a CD/DVD database may include the physical location of each CD/DVD (e.g., its storage location such as a slot number in jukebox 80), the identity of the CD/DVD and the content on each CD/DVD. Likewise, the databases(s) associated with the hard drive identifies each item of programming content available on the hard drive. The media server 100 can cross-correlate among the different databases to locate and identify any particular item of programming. For example, if the content identifying signal specifies that the vehicle is currently rendering CD “A,” which includes songs “X,” “Y,” and “Z,” the media server 100 first searches the CD/DVD database to locate CD “A.” If the CD is not available in the jukebox 80, the media server 100 may search the hard drive database to determine if CD “A” is available, perhaps in an MP3 or other multimedia format. If CD “A” itself is not available, the media server 100 can further search the hard drive database to determine if the individual songs “X,” “Y,” and “Z” are available even though they are not associated with CD “A.”

The media server 100 may begin playing the programming content at the same elapsed time the vehicle's CD player 324 stopped playing the content, perhaps with a pre-specified delay to allow time for the user to enter the home. Alternatively, the media server may begin playing the content from the beginning of the selection (e.g., song) that was being played by the CD player 324 at some earlier elapsed time so that the user will not miss any of the selection as he or she makes the transition from the vehicle to the home (or visa versa). Alternatively, the media server 100 may begin playing the next selection in the sequence, particularly if the selection being rendered in the vehicle is nearing its end. In yet another alternative the media server 100 may queue the content so that it is ready to be rendered, but the content is not actually rendered until the occurrence of another triggering event (e.g., the user enters the home and turns on a light or a motion detector detects the user's presence in the home). In some cases the vehicle 20 will have a user selectable feature that allows the user to deselect the synchronization process all together.

The home network may maintain a priority or override scheme so that when the mobile user leaves the vehicle and the content is to be rendered in one or more locations in the house it will not interrupt other residents who may be currently enjoying programming in various parts of the home. For example, in one scheme, if a particular television is already in use (as determined, for example, by sensing the power consumed by the television) then that television will not be overridden. In another example, a time-based override scheme may be employed so that, for instance, content will not be synchronized with the vehicle and rendered in the home after a certain time of day (e.g., 8 pm). On the other hand, the mobile user may have priority over the other residents and thus the content he or she was enjoying in the vehicle will override certain other residents or certain locations in the home. In some cases the mobile user may program the home network so that when the content is rendered in the home it will be rendered in selected rooms so that the content will follow him or her around and he or she goes from room to room. For instance, the content may first be rendered in the garage when the vehicle first arrives home, then in the kitchen, and so on. In this way the mobile user will always have access to the programming content when following a route through the house. Such a scheme may be subject to any priorities or other restrictions that may have been programmed into the home network. A scheme may use a previously established route through the premises or may involve tracking the actual location of the user on the premises.

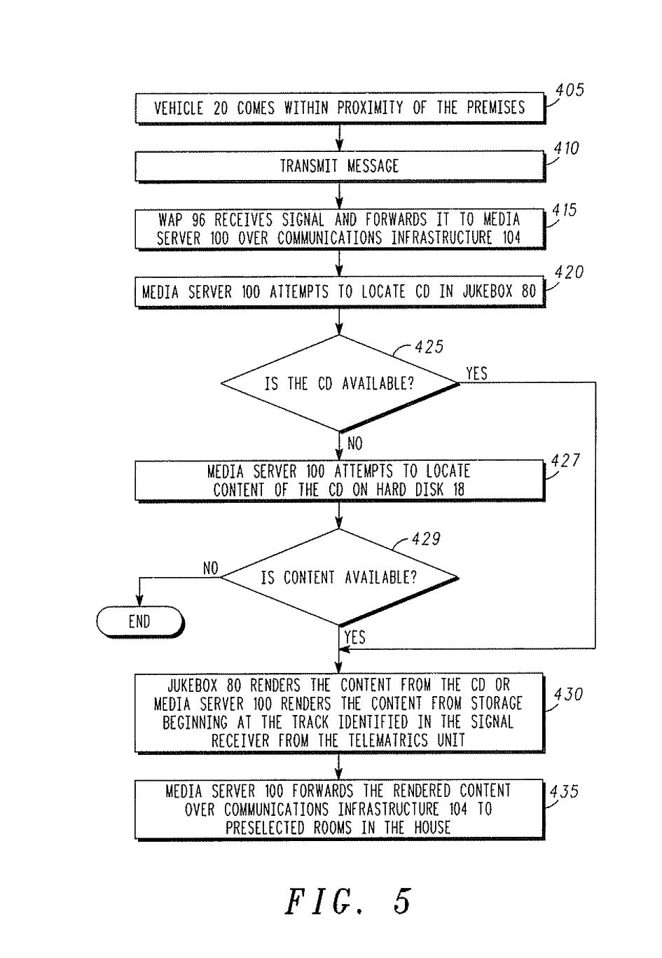

FIG. 5 is a flowchart showing one example of how the synchronization process discussed herein may be used when a mobile user is listening to music on a CD in the vehicle 20 and returns home. First, in step 405 the vehicle comes within proximity of the premises (e.g., it reaches the street on which the premises is located or the driveway of the premises or identifies some other triggering event). In step 410 the mobile user manually activates vehicle's telematics unit so that it transmits a wireless signal requesting synchronization and identifying the CD and track currently being rendered. Of course, the telematics unit may be configured to automatically transmit this signal when coming within proximity of the premises using, for example, any of the aforementioned triggering events. The WAP 96 receives the signal in step 415 and forwards it to media server 100 over communication infrastructure 104. In step 420, the Media server 100 attempts to locate the CD in the jukebox 80. At decision step 425, the media server 100 determines if the CD available. If not, the media server 100 attempts to locate, in step 427, the content of the CD on another medium such as its hard disk 118. If the content is available on the CD, the jukebox 80 renders the content from the CD beginning with the track identified in the signal received from the telematics unit in step 430. If at decision step 429 the content is not available, the process ends. Alternatively, if the media server 100 locates the content on another available storage medium such as hard disk 118, the media server 100 renders the content, once again beginning with the track identified in the signal received from the telematics unit in step 430. In either case, the media server 100 forwards the rendered content over communications infrastructure 104, in step 435, to preselected rooms in the house.

FIG. 6 shows one example of a hardware platform 600 that may be used in either the vehicle or the home to implement the methods described herein. In the case of the vehicle, the hardware platform 600 in some implementations may be associated with the telematics unit. In the case of the home, the hardware platform 600 in some implementations may be associated with the WAP 96 and the media server 100. The hardware platform 600 includes a content interface 604 that receives content to be rendered. The content is forwarded to an output unit 606 that renders the content. An input interface 602 identifies the occurrence of a triggering event upon receipt of an appropriate signal and in turn notifies a processor 608. The processor 608 is in communication with the content interface 604. The processor 608, in response to the triggering event, generates a message that reflects the status of the media content. The message in turn is transmitted by the transmitter 610.

In some implementations the content interface 602 will be a broadcast antenna (if the content is a broadcast signal), an input/output port to an optical reader (in the case of a CD or DVD player) or other storage medium such as a hard disk. In the case of the vehicle, the input interface 602 will be activated upon occurrence of a triggering event indicating that the user is leaving the home to enter the vehicle. In the case of the home, the input interface 602 will be activated upon occurrence of a triggering event indicating that the vehicle has come within proximity of the home user or is leaving the vehicle to enter the home.

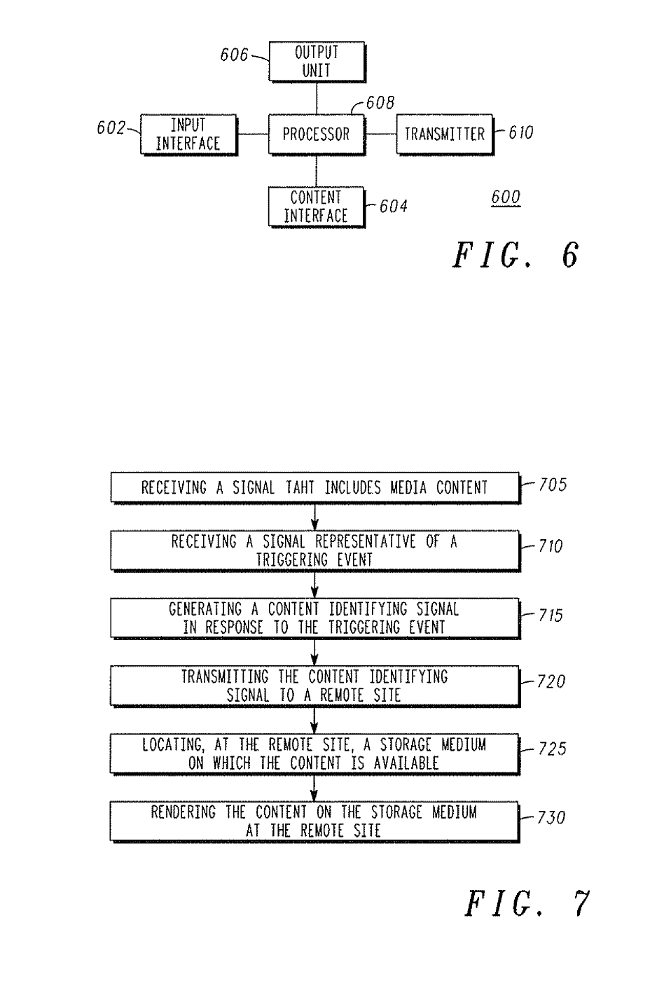

FIG. 7 is a flowchart that shows one example of a process performed by the hardware platform 600 and the systems located in the vehicle or home that renders synchronized content in response to receipt of a content-identifying signal from the hardware platform 600. The method begins in step 705 by receiving a signal that includes the media content. Upon occurrence of a triggering event, the hardware platform receives a signal representative of the triggering event in step 710. In response, the hardware platform generates a content-identifying signal (step 715) and transmits the content-identifying signal to a remote site (e.g., the vehicle or the home) in step 720. At the remote site, a storage medium is located on which the content is available (step 725). Finally, in step 730 the content is rendered in the desired manner.

The processes shown above that are performed by the home network 70 and the vehicle 20 may be implemented in a general, multi-purpose or single purpose processor. Such a processor will execute instructions, either at the assembly, compiled or machine-level, to perform that process. Those instructions can be written by one of ordinary skill in the art following the description herein and stored or transmitted on a computer readable medium. The instructions may also be created using source code or any other known computer-aided design tool. A computer readable medium may be any medium capable of carrying those instructions and include a CD-ROM, DVD, magnetic, optical or other storage, tape, silicon memory (e.g., removable, non-removable, volatile or non-volatile), packetized or non-packetized wireline or wireless transmission signals.

Although various embodiments are specifically illustrated and described herein, it will be appreciated that modifications and variations of the present invention are covered by the above teachings and are within the purview of the appended claims without departing from the spirit and intended scope of the invention. For example, while synchronization between media sources located in a vehicle and a residence or other premises have been described, other types of mobile or portable systems or apparatuses may be employed instead of a vehicle that serves to provide transportation. For example, portable media players or systems such as PDAs, notebook computers, headsets, MP3 players and the like may also have media sources that are synchronized with media sources located on a premises. In these alternative systems the portable devices can communicate directly with the home. That is, the portable system can communicate the content-identifying signal directly to the home and receive signals directly from the home.

1. At least one computer-readable medium encoded with a computer program comprising instructions which, when executed by a processor, performs a method including:
receiving a wireless content-identifying signal from a mobile apparatus through an access device located on a premises, said wireless content-identifying signal identifying a first source of programming content that is available to a first rendering device associated with the mobile apparatus;
based on the wireless content-identifying signal, identifying a second source of the programming content that is available to a second rendering device located on the premises; and
transmitting a control signal to the second rendering device directing the second rendering device to access and render the programming content.

2. The computer-readable medium of claim 1 wherein the content-identifying signal is received after occurrence of a triggering event causing generation of a triggering signal indicating that the mobile apparatus and the premises are within a predefined proximity of one another.

3. The computer-readable medium of claim 2 wherein the triggering signal is a wireless signal and the triggering signal and the content identifying signal are incorporated in a common signal.

4. The computer-readable medium of claim 2 wherein the mobile apparatus is a vehicle and the triggering event indicates that a passenger is departing or has departed from the vehicle.

5. The computer-readable medium of claim 2 wherein the triggering event is actuation of a sensor by the mobile apparatus, said sensor being associated with a communications network located on the premises.

6. The computer-readable medium of claim 2 further comprising using a global positioning system unit located in the mobile apparatus to determine that the mobile apparatus and the premises are within the predefined proximity of one another.

7. The computer-readable medium of claim 1 further comprising forwarding the programming content from the second rendering device over a communications network to a selected part of the premises.

8. The computer-readable medium of claim 1 when the programming content is rendered by the second rendering device at an elapsed point that is earlier than the elapsed point at the occurrence of the triggering event.

9. The computer-readable medium of claim 1 wherein the first source of programming content is a CD or DVD and the second source of programming content is a mass storage medium.

10. The computer-readable medium of claim 1 further comprising downloading the programming content from the first source of programming content to the second source of programming content so that the programming content is available to the second rendering device.

11. The computer-readable medium of claim 1 wherein the mobile apparatus is a portable media player.

12. At least one computer-readable medium encoded with a computer program comprising instructions which, when executed by a processor, performs a method including:
determining that a mobile apparatus and a select premises are within a predefined proximity of one another; and
in response to the determination, transmitting a wireless content-identifying signal between the mobile apparatus and an access device located on the select premises, said wireless content-identifying signal identifying a first source of programming content that is available to a first rendering device associated with at least one of the mobile apparatus and the select premises.

13. The computer-readable medium of claim 12 further comprising transmitting a control signal to a second rendering device associated with the other one of the mobile apparatus and the select premises, thereby directing the second rendering device to access and render the programming content.

14. The computer-readable medium of claim 12 wherein the triggering event causes generation of a triggering signal indicating that the mobile apparatus and the select premises are within a predefined proximity of one another.

15. The computer-readable medium of claim 14 wherein the triggering signal is a wireless signal and the triggering signal and the content identifying signal are incorporated in a common signal.

16. The computer-readable medium of claim 13 wherein the mobile apparatus is a vehicle and the triggering event indicates that a user is entering or will enter the vehicle or the vehicle.

17. The computer-readable medium of claim 13 wherein the triggering event is actuation of a sensor at the mobile apparatus, said sensor communicating with a communications network located on the select premises.

18. The computer-readable medium of claim 12 further comprising using a global positioning system unit located in the mobile apparatus to determine when the mobile apparatus comes within or departs from a predefined proximity of the select premises.

19. At least one computer medium encoded with a computer program comprising instructions, which, when executed by a processor, performs a method including:
receiving a wireless content-identifying signal from a mobile apparatus through an access device located on a premises, said wireless content-identifying signal identifying a first source of programming content that is available to a first rendering device associated with the mobile apparatus;
based on the wireless content-identifying signal, identifying a second source of the programming content that is available to a second rendering device located on the premises; and
queuing the programming content from the second source so that it is available to the second rendering device.

20. The computer readable medium of claim 19 further comprising rendering, with the second rendering device, the programming content from the second source in at least a selected part of the premises.

21. The computer readable medium of claim 19 wherein the wireless content-identifying signal is received after occurrence of a triggering event causing generation of a triggering signal indicating that the mobile apparatus and the premises are within a predefined proximity of one another.

22. The computer readable medium of claim 21 wherein the triggering signal is a wireless signal and the triggering signal and the wireless content identifying signal are incorporated in a common signal.

23. The computer readable medium of claim 21 wherein the mobile apparatus is a vehicle and the triggering event indicates that a passenger is departing or has departed from the vehicle.

24. The computer readable medium of claim 21 wherein the triggering event is actuation of a sensor by the mobile apparatus, said sensor being associated with a communications network located on the premises.

25. The computer readable medium of claim 20 further comprising forwarding the rendered programming content from the second rendering device over a communications network to the at least a selected part of the premises.

26. The computer readable medium of claim 19 further comprising rendering the programming content by the second rendering device at an elapsed time that is earlier than the elapsed time at the occurrence of the triggering event.

27. The computer readable medium of claim 19 wherein the first source of programming content is a CD or a DVD and the second source of programming content is a mass storage medium.

28. The computer readable medium of claim 19 further comprising downloading the programming content from the first source to the second source so that the programming content is available to the second rendering device.

29. An electronic device comprising:
a content interface that receives first signals carrying media content;
an input interface that receives a second signal indicating a triggering event and outputs a third signal upon receiving the second signal;
a processor that receives the second signal from the input interface and in response to the second signal generates a message indicating a status of the media content; and
a transmitter that receives the message from the processor and transmits the message.

30. The electronic device of claim 29 wherein the content interface is located in a mobile apparatus or on a premises and the triggering event indicates that the mobile apparatus and the premises are at a predefined proximity of one another.

31. The electronic device of claim 29 wherein the second signal identifies the media content.
